(19) United States
(12) Patent Application Publication
(10) Pub. No.: US 2016/0145372 A1
(43) Pub. Date: May 26, 2016

(54) HYDROLYSIS-RESISTANT POLYURETHANE MOULDING

(71) Applicant: BASF SE, Ludwigshafen (DE)

(72) Inventors: Amir DOROODIAN, Osnabrück (DE); Yan HE, Lemförde (DE)

(21) Appl. No.: 14/901,171

(22) PCT Filed: May 28, 2014
(86) PCT No.: PCT/EP2014/061072

§ 371 Date: Dec. 28, 2015

(30) Foreign Application Priority Data
Jun. 28, 2013 (EP) 13174414.6

(51) Int. Cl. C08G 18/08; C08G 18/76; C08G 18/48; C08G 18/18; C08G 18/42

(52) U.S. Cl. CPC C08G 18/14; C08G 18/1808; C08G 18/425; C08G 18/4833; C08G 18/7664; C08G 2101/0083

(57) ABSTRACT

The present invention relates to a process for producing polyurethane moldings, wherein (a) organic polyisocyanates are mixed with (b) compounds having at least two hydrogen atoms which are reactive toward isocyanate and comprising polyesterol (b1) and at least one compound (b2) obtainable by alkoxylation of an aromatic starter molecule, (c) blowing agent, (d) catalyst, and (e) optionally other auxiliaries and/or additives to form a reaction mixture and the reaction mixture is introduced into a mold and allowed to react to give a polyurethane molding. The present invention further relates to polyurethane moldings obtainable by such a process and also the use of these moldings as steering wheel, seat, armrest and in particular as shoe sole.

The present invention relates to a process for producing polyurethane moldings having a density of from 150 to 850 WI, wherein (a) organic polyisocyanates are mixed with (b) compounds having at least two hydrogen atoms which are reactive toward isocyanate and comprising polyesterol (b1) and at least one compound (b2) obtainable by alkoxylation of an aromatic starter molecule, (c) blowing agent, (d) catalyst, and (e) optionally other auxiliaries and/or additives to form a reaction mixture and the reaction mixture is introduced into a mold and allowed to react to give a polyurethane molding. The present invention further relates to polyurethane moldings obtainable by such a process and also the use of these moldings as steering wheel, seat, armrest and in particular as shoe sole.

Moldings composed of foamed polyurethanes are known and can be used for a wide variety of applications. In most applications, they are produced on the basis of polyethers or polyesters as polyols. The polyester polyurethanes have better mechanical properties compared to the polyether polyurethanes. Furthermore, the PESOL polyurethanes (polyesterol-based polyurethanes) have improved swelling resistance toward organic substances such as isooctane. This swelling resistance is an important requirement for use as safety shoe and cannot be fulfilled by polyether polyurethane. A disadvantage of the polyester polyurethanes is that these are susceptible to hydrolysis in a hot and humid environment. Foams are particularly affected because of their large surface area per unit volume.

Polyesterols obtained by polycondensation of C4-C6-dicarboxylic acids with polyfunctional alcohols are usually employed for producing polyurethanes based on polyesterols. However, these polyurethanes have the disadvantage that they have an unsatisfactory hydrolysis stability. To improve the hydrolysis stability of polyurethanes based on polyesterols, these C4-C6-dicarboxylic acids are, for example, replaced by more hydrophobic dicarboxylic acids. Thus, US 2005124711 describes microcellular polyester polyurethanes obtained from polyesterols obtained from dimeric fatty acids.

US 2011/0190406 describes the use of bisphenol A as diol for the preparation of polyesterols and the use of the latter in the production of shoe soles, but the hydrolysis properties of shoe soles are not discussed.

WO 2004/050735 describes the use of polyesterols based on a combination of an orthophthalic acid and a dicarboxylic acid having 8-12 carbon atoms for improving the hydrolysis stability.

A disadvantage of these polyesters having improved hydrolysis stability is that the raw materials used are expensive. Furthermore, the mechanical properties are poorer than those of polyurethanes based on classical polyesterols obtained by polycondensation of C4-C6-dicarboxylic acids with polyfunctional alcohols. Finally, the isooctane swelling increases when the classical polyesterols are replaced by solutions according to US 2005124711 or WO 2004/050735 due to the lower polarity of the latter, as a result of which these solutions have only limited suitability for producing safety shoes.

It was an object of the present invention to provide elastomeric polyurethane moldings, in particular elastomeric polyurethane integral foams which are based on polyesterols and have improved hydrolysis stability and excellent mechanical properties and are suitable, in particular, as material for soles of safety shoes.

The object of the invention has been able to be achieved by an elastomeric polyurethane molding having a density of from 150 to 850 WI which can be produced by a process in which (a) organic polyisocyanates are mixed with (b) compounds having at least two hydrogen atoms which are reactive toward isocyanate and comprising polyesterol (b1) and at least one compound (b2) obtainable by alkoxylation of an aromatic starter molecule, (c) blowing agent, (d) catalyst, and (e) optionally other auxiliaries and/or additives to form a reaction mixture and the mixture is introduced into a mold and allowed to react to give a polyurethane molding.

The polyurethane moldings of the invention are elastomeric polyurethane foams, preferably polyurethane integral foams. For the purposes of the present invention, an elastomeric polyurethane foam is a polyurethane foam in accordance with DIN 7726 which after brief deformation by 50% of the thickness in accordance with DIN 53577 has no remaining deformation of more than 5% of its original thickness after 10 minutes. For the purposes of the invention, polyurethane integral foams are polyurethane foams in accordance with DIN 7726 having an outer zone which due to the shaping process has a higher density than the core. The overall foam density averaged over the core and the outer zone is from 150 g/I to 850 WI, more preferably from 180 WI to 750 WI, particularly preferably from 200 g/l to 650 g/I.

The organic and/or modified polyisocyanates (a) used for producing the polyurethane foam moldings of the invention comprise the aliphatic, cycloaliphatic and aromatic bifunctional or polyfunctional isocyanates (constituent a-1) and mixtures thereof known from the prior art. Examples are monomeric diphenylmethane diisocyanate (MMDI), e.g. diphenylmethane 4,4′-diisocyanate, diphenylmethane 2,4′-diisocyanate, mixtures of monomeric diphenylmethane diisocyanates and homologs of diphenylmethane diisocyanate having more than two rings (polymeric MDI), tetramethylene diisocyanate, hexamethylene diisocyanate (HDI), isophorone diisocyanate (IPDI), tolylene 2,4- or 2,6-diisocyanate (TDI) or mixtures of the isocyanates mentioned.

Preference is given to using 4,4′-MDI. The 4,4′-MDI which is preferably used can comprise from 0 to 20% by weight of 2,4′-MDI and small amounts, up to about 10% by weight, of allophanate- or uretonimine-modified polyisocyanates. Small amounts of polyphenylenepolymethylene polyisocyanate (polymeric MDI) can also be used. The total amount of these high-functionality polyisocyanates should not exceed 5% by weight of the isocyanate used.

The polyisocyanate component (a) is preferably used in the form of polyisocyanate prepolymers. These polyisocyanate prepolymers can be obtained by reaction, for example at temperatures from 30 to 100° C., preferably at about 80° C., of polyisocyanates (a-1) as described above with compounds (a-2) having at least two hydrogen atoms which are reactive toward isocyanate to form the prepolymer.

Compounds (a-2) of this type having at least two hydrogen atoms which are reactive toward isocyanate are known to those skilled in the art and are described, for example, in “Kunststoffhandbuch, volume 7, Polyurethane”, Carl Hanser Verlag, 3rd edition 1993, chapter 3.1, Preference is given to using the polyesterols described under b).

The polyols (b) comprise polyesterols (b1) and at least one compound (b2), obtainable by alkoxylation of an aromatic starter molecule. Polyesterols having at least two hydrogen atoms which are reactive toward isocyanate groups are used as polyesterols. Polyesterols preferably have a number-average molecular weight of greater than 450 g/mol, particularly preferably from >500 to <8000 g/mol and in particular from 600 to 3500 g/mol and a functionality of from 2 to 4, in particular from 2 to 3.

Polyester polyols (b1) can, for example, be prepared from organic dicarboxylic acids having from 2 to 12 carbon atoms, preferably aliphatic dicarboxylic acids having from 4 to 6 carbon atoms, and polyhydric alcohols, preferably diols, having from 2 to 12 carbon atoms, preferably from 2 to 6 carbon atoms. Possible dicarboxylic acids are, for example: succinic acid, glutaric acid, adipic acid, suberic acid, azelaic acid, sebacic acid, decanedicarboxylic acid, maleic acid, fumaric acid, phthalic acid, isophthalic acid and terephthalic acid. The dicarboxylic acids can be used either individually or in admixture with one another. The corresponding dicarboxylic acid derivatives, e.g. dicarboxylic esters of alcohols having from 1 to 4 carbon atoms or dicarboxylic anhydrides, can also be used instead of the free dicarboxylic acids. Preference is given to using dicarboxylic acid mixtures of succinic, glutaric and adipic acids in weight ratios of for example 20-35:35-50:20-32 and in particular adipic acid. Examples of dihydric and polyhydric alcohols, in particular diols, are: ethanediol, diethylene glycol, 1,2- or 1,3-propanediol, dipropylene glycol, 1,4-butanediol, 1,5-pentanediol, 1,6-hexanediol, 1,10-decanediol, glycerol and trimethylolpropane. Preference is given to using ethanediol, diethylene glycol, 1,4-butanediol, 1,5-pentanediol and 1,6-hexanediol. It is also possible to use polyester polyols derived from lactones, e.g. ε-caprolactone, or hydroxycarboxylic acids, e.g. w-hydroxycaproic acid.

To prepare the polyester polyols (b1) the organic, e.g. aromatic and preferably aliphatic polycarboxylic acids and/or derivatives and polyhydric alcohols can be polycondensed in the absence of catalysts or preferably the presence of esterification catalysts, advantageously in an atmosphere of inert gas, e.g. nitrogen, carbon monoxide, helium, argon, etc. in the melt at temperatures of from 150 to 250° C., preferably from 180 to 220° C., optionally under reduced pressure, to the desired acid number which is preferably less than 10, particularly preferably less than 2. In a preferred embodiment, the esterification mixture is polycondensed at the abovementioned temperatures to an acid number of from 80 to 30, preferably from 40 to 30, under atmospheric pressure and subsequently under a pressure of less than 500 mbar, preferably from 50 to 150 mbar. Possible esterification catalysts are, for example, iron, cadmium, cobalt, lead, zinc, antimony, magnesium, titanium and tin catalysts in the form of metals, metal oxides or metal salts. However, the polycondensation can also be carried out in the liquid phase in the presence of diluents and/or entrainers such as benzene, toluene, xylene or chlorobenzene to azeotropically distill off the water of condensation. The organic polycarboxylic acids and/or derivatives and polyhydric alcohols are advantageously polycondensed in a molar ratio of 1:1-1.8, preferably 1:1.05-1.2, to prepare the polyester polyols.

Further suitable polyesterols (b1) are polymer-modified polyesterols, preferably graft polyesterols. These are polymer polyesterols which usually have a content of, preferably thermoplastic, polymers of from 5 to 60% by weight, preferably from 10 to 55% by weight, particularly preferably from 15 to 50% by weight and in particular from 20 to 40% by weight. These polymer polyesterols are described, for example, in WO 05/098763 and EP-A-250 351 and are usually prepared by free-radical polymerization of suitable olefinic monomers, for example styrene, acrylonitrile, (meth)acrylates, (meth)acrylic acid and/or acrylamide, in a polyesterol serving as graft base. The side chains are generally formed by transfer of the free radicals of growing polymer chains to polyesterols or polyetherols. The polymer polyesterol comprises, in addition to the graft copolymer, mainly the homopolymers of the olefins dispersed in unchanged polyesterol.

In a preferred embodiment, acrylonitrile, styrene, preferably acrylonitrile and styrene, are used as monomers. The monomers are optionally polymerized in the presence of further monomers, a macromer, i.e. an unsaturated, free-radically polymerizable polyol, a moderator and using a free-radical initiator, usually azo or peroxide compounds, in a polyesterol or polyetherol as continuous phase. This process is, for example, described in DE 111 394, U.S. Pat. No. 3,304,273, U.S. Pat. No. 3,383,351, U.S. Pat. No. 3,523,093, DE 1 152 536 and DE 1 152 537.

During the free-radical polymerization, the macromers are incorporated into the copolymer chain. This forms block copolymers which have a polyester block and a polyacrylonitrile-styrene block and act as phase compatibilizers in the interface between the continuous phase and dispersed phase and suppress agglomeration of polymer polyesterol particles. The proportion of macromers is usually from 1 to 20% by weight, based on the total weight of the monomers used for preparing the polymer polyol.

If polymer polyesterol is comprised, this is preferably present together with further polyesterols. The proportion of polymer polyol is particularly preferably greater than 5% by weight, based on the total weight of the component (b). The polymer polyesterols can, for example, be comprised in an amount of from 7 to 90% by weight or from 11 to 80% by weight, based on the total weight of the component (b).

A compound (b2) obtainable by alkoxylation of an aromatic starter molecule is used in addition to polyesterols (b1). Depending on the chain length, this compound can come under the definition of polymeric compounds having at least two hydrogen atoms which are reactive toward isocyanates or of chain extenders and optionally of crosslinkers. Suitable aromatic starter molecules for this purpose are, for example, phenylenediamine, 2,3-, 2,4- and 2,6-toluenediamine (TDA), 4,4′-, 2,4′- and 2,2′-diaminodiphenylmethane (MDA), polymeric MDA, and bisphenols.

The aromatic starter molecule preferably has at least two benzene rings and is particularly preferably a bisphenol or a derivative of a bisphenol. For the purposes of the invention, derivatives are compounds in which hydrogen atoms on aromatic or aliphatic carbon atoms are replaced by halogen atoms or hydrocarbon radicals such as alkyl or aryl radicals. These hydrocarbon radicals can be unsubstituted or substituted, for example by halogen atoms, oxygen, sulfur or phosphorus. They can be used individually or in the form of mixtures.

Bisphenols comprise bisphenol A, bisphenol AF, bisphenol AP, bisphenol BP, bisphenol C, bisphenol E, bisphenol F, bisphenol FL, bisphenol G, bisphenol M, bisphenol P, bisphenol PH, bisphenol S, bisphenol TMC and bisphenol Z. Particular preference is given to using bisphenol A and/or bisphenol S and in particular bisphenol A as aromatic starter molecule.

The compounds (b2) are obtained by alkoxylation of the starter molecule by means of alkylene oxides. For example, they can be obtained by anionic polymerization of the starter molecules by means of alkylene oxides using alkali metal hydroxides such as sodium or potassium hydroxide or alkali metal alkoxides such as sodium methoxide, sodium or potassium ethoxide or potassium isopropoxide as catalysts. Suitable alkylene oxides are, for example, tetrahydrofuran, 1,3-propylene oxide, 1,2- or 2,3-butylene oxide, styrene oxide and preferably ethylene oxide and 1,2-propylene oxide. The alkylene oxides can be used individually, alternately in succession or as mixtures. Preference is given to using ethylene oxide or propylene oxide, in particular propylene oxide, as alkylene oxide.

The alkoxylation products of an aromatic starter molecule can be used in unchanged form. Optionally, one or both or, if present, also further OH groups of the alkoxylation product of an aromatic starter molecule can also be converted into an amino group/amino groups in order to increase the reactivity. Compounds which can be obtained by alkoxylation of an aromatic starter molecule therefore comprise both the directly obtainable alkylation products and the reaction products of these alkylation products to effect functionalization of the OH groups, for example the products of conversion into the amine.

Compounds (b2) according to the invention, which can be obtained by alkoxylation of an aromatic starter molecule, preferably have a hydroxyl number of from 80 to 400 mg KOH/g, particularly preferably from 100 to 320 mg KOH/g and in particular from 120 to 250 mg KOH/g. Alkoxylation products of bisphenol A as starter with propylene oxide are marketed under the trade name SynFac® by Milliken Chemical. Here, the proportion of component (b2) is, based on the total weight of the component (b), preferably from 0.01 to 10% by weight, particularly preferably from 0.1 to 6% by weight and in particular from 0.5 to 4% by weight.

Apart from polyesterols (b1) and compound (b2) obtained by alkoxylation of an aromatic starter molecule, it is also possible to use further polyols which are customary in polyurethane chemistry and have a number-average molecular weight of greater than 500 g/mol, for example polyetherols. However, the proportion of the further polyols is preferably less than 40% by weight, particularly preferably less than 20% by weight, very particularly preferably less than 10% by weight, more preferably less than 5% by weight and in particular 0% by weight, based on the total weight of polyesterols (b) and the further polyols.

Furthermore, the compounds having at least 2 hydrogen atoms which are reactive toward isocyanate can comprise chain extenders and/or crosslinkers. For the purposes of the present invention, chain extenders and/or crosslinkers are substances having a molecular weight of preferably less than 450 g/mol, particularly preferably from 60 to 400 g/mol, with chain extenders having 2 hydrogen atoms which are reactive toward isocyanates and crosslinkers having 3 hydrogen atoms which are reactive toward isocyanates. These can preferably be used individually or in the form of mixtures. Preference is given to using diols and/or triols having molecular weights of less than 400, particularly preferably from 60 to 300 and in particular from 60 to 150. Possibilities are, for example, aliphatic, cycloaliphatic and/or araliphatic diols having from 2 to 14, preferably from 2 to 10, carbon atoms, e.g. ethylene glycol, 1,3-propanediol, 1,10-decanediol, 1,2-, 1,3-, 1,4-dihydroxycyclohexane, diethylene glycol, dipropylene glycol and 1,4-butanediol, 1,6-hexanediol and bis(2-hydroxyethyl)hydroquinone, triols such as 1,2,4-, 1,3,5-trihydroxycyclohexane, glycerol and trimethylolpropane, and low molecular weight hydroxyl-comprising polyalkylene oxides based on ethylene oxide and/or 1,2-propylene oxide and the abovementioned diols and/or triols as starter molecules. Particular preference is given to using monoethylene glycol, 1,4-butanediol, diethylene glycol, glycerol or mixtures thereof as chain extenders (f).

If chain extenders, crosslinkers or mixtures thereof are employed, they are advantageously used in amounts of from 1 to 60% by weight, preferably from 1.5 to 50% by weight and in particular from 2 to 40% by weight, based on the weight of the component b).

Furthermore, blowing agents c) are present in the production of polyurethane foam moldings. These blowing agents c) can comprise water. Apart from water, generally known chemically and/or physically acting compounds can additionally be used as blowing agents c). For the purposes of the present invention, chemical blowing agents are compounds which react with isocyanate to form gaseous products, for example water or formic acid. Physical blowing agents are compounds which are dissolved or emulsified in the starting materials for polyurethane production and vaporize under the conditions of polyurethane formation. These are, for example, hydrocarbons, halogenated hydrocarbons and other compounds, for example perfluorinated alkanes, such as perfluorohexane, chlorofluorocarbons and ethers, esters, ketones, acetals or mixtures thereof, for example (cyclo)aliphatic hydrocarbons having from 4 to 8 carbon atoms or fluorinated hydrocarbons such as Solkane® 365 mfc from Solvay Fluorides LLC. In a preferred embodiment, a mixture comprising at least one of these blowing agents and water is used as blowing agent; in particular water is used as only blowing agent. If no water is used as blowing agent, exclusively physical blowing agents are preferably used.

The content of water is, in a preferred embodiment, from 0.1 to 2% by weight, preferably from 0.2 to 1.5% by weight, particularly preferably from 0.3 to 1.2% by weight, based on the total weight of the components (a) to (e).

In a further preferred embodiment, hollow microspheres comprising physical blowing agent are added as additional blowing agent in the reaction of the components (a) to (e). The hollow microspheres can also be used in admixture with the abovementioned blowing agents.

The hollow microspheres usually comprise a shell of thermoplastic polymer and are filled with a liquid, low-boiling substance based on alkanes in the core. The production of such hollow microspheres is described, for example, in U.S. Pat. No. 3,615,972. The hollow microspheres generally have a diameter of from 5 to 50 μm. Examples of suitable hollow microspheres are obtainable under the trade name Expancell® from Akzo Nobel.

The hollow microspheres are generally added in an amount of from 0.5 to 5% by weight, based on the total weight of the components b), c) and f).

As catalysts (d) for producing the polyurethane foams, preference is given to using compounds which strongly accelerate the reaction of the compounds (b) having at least two hydrogen atoms which are reactive toward isocyanates with the organic, optionally modified polyisocyanates (a). Examples which may be mentioned are amidines such as 2,3-dimethyl-3,4,5,6-tetrahydro-pyrimidine, tertiary amines such as triethylamine, tributylamine, dimethylbenzylamine, N-methyl-morpholine, N-ethylmorpholine, N-cyclohexylmorpholine, N,N,N′,N′-tetramethylethylenediamine, N,N,N′,N′-tetramethylbutanediamine, N,N,N′,N′-tetramethylhexanediamine, pentamethyl-diethylenetriamine, bis(dimethylaminoethyl) ether, bis(dimethylaminopropyl)urea, dimethylpiperazine, 1,2-dimethylimidazole, 1-azabicyclo[3.3.0]octane and preferably 1,4-diaza-bicyclo[2.2.2]octane and alkanolamine compounds such as triethanolamine, triisopropanol-amine, N-methyldiethanolamine and N-ethyldiethanolamine and dimethylethanolamine. Further possible compounds are organic metal compounds, preferably organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate, and also bismuth carboxylates such as bismuth(III) neodecanoate, bismuth 2-ethylhexanoate and bismuth octanoate or mixtures thereof. The organic metal compounds can be used either alone or preferably in combination with strongly basic amines. Preference is given to using exclusively amine catalysts as catalysts (d).

Preference is given to using from 0.001 to 5% by weight, in particular from 0.05 to 2% by weight, of catalyst or catalyst combination, based on the weight of the component (b).

Auxiliaries and/or additives (e) can optionally also be added to the reaction mixture for producing the polyurethane foams. Mention may be made by way of example of mold release agents, fillers, dyes, pigments, hydrolysis inhibitors, odor-absorbing substances and fungistatic and/or bacteriostatic substances.

Suitable mold release agents are, for example: reaction products of fatty acid esters with polyisocyanates, salts derived from polysiloxanes comprising amino groups and fatty acids, salts derived from saturated or unsaturated (cyclo)aliphatic carboxylic acids having at least 8 carbon atoms and tertiary amines and also, in particular, internal mold release agents such as carboxylic esters and/or carboxamides prepared by esterification or amidation of a mixture of montanic acid and at least one aliphatic carboxylic acid having at least 10 carbon atoms with at least bifunctional alkanolamines, polyols and/or polyamines having molecular weights of from 60 to 400 g/mol, as disclosed, for example, in EP 153 639, mixtures of organic amines, metal salts of stearic acid and organic monocarboxylic and/or dicarboxylic acids or anhydrides thereof, as disclosed, for example, in DE-A-3 607 447, or mixtures of an imino compound, the metal salt of a carboxylic acid and optionally a carboxylic acid, as disclosed, for example, in U.S. Pat. No. 4,764,537. Reaction mixtures according to the invention preferably do not contain any further mold release agents.

For the purposes of the present invention, fillers, in particular reinforcing fillers, are the customary organic and inorganic fillers, reinforcing materials, weighting agents, coating compositions, etc., known per se. Specific examples which may be mentioned are: inorganic fillers such as siliceous minerals, for example sheet silicates such as antigorite, bentonite, serpentine, hornblendes, amphiboles, chrysotile and talc, metal oxides such as kaolin, aluminum oxides, titanium oxides, zinc oxide and iron oxides, metal salts such as chalk and barite, and inorganic pigments such as cadmium sulfide, zinc sulfide and also glass, etc. Preference is given to using kaolin (China clay), aluminum silicate and coprecipitates of barium sulfate and aluminum silicate. Examples of possible organic fillers are: carbon black, melamine, rosin, cyclopentadienyl resins and graft polymers and also cellulose fibers, polyamide fibers, polyacrylonitrile fibers, polyurethane fibers, polyester fibers based on aromatic and/or aliphatic dicarboxylic esters and in particular carbon fibers.

The inorganic and organic fillers can be used either individually or as mixtures and are advantageously added in amounts of from 0.5 to 50% by weight, preferably from 1 to 40% by weight, based on the weight of the components (a) to (e), to the reaction mixture.

The hydrolysis stability of polyester polyurethanes can be significantly improved by the addition of additives such as carbodiimides. Such materials are commercially available under trade names such as Elastostab™ or Stabaxol™.

In the process of the invention, the starting components (a) to (e) are mixed with one another in such amounts that the equivalence ratio of NCO groups of the polyisocyanates (a) to the sum of the reactive hydrogen atoms of the components (b) and (c) is from 1:0.8 to 1:1.25, preferably from 1:0.9 to 1:1.15. Here, a ratio of 1:1 corresponds to an isocyanate index of 100. For the purposes of the present invention, the isocyanate index is the stoichiometric ratio of isocyanate groups to groups which are reactive toward isocyanate, multiplied by 100.

The present invention further provides a polyurethane molding obtainable by the process of the invention.

The polyurethane foam moldings of the invention are preferably produced by the one-shot process using the low-pressure or high-pressure technique in closed, advantageously heated molds. The molds usually consist of metal, e.g. aluminum or steel. These modes of operation are described, for example, by Piechota and Röhr in “Integralschaumstoff”, Carl-Hanser-Verlag, Munich, Vienna, 1975, or in the “Kunststoff-handbuch”, volume 7. Polyurethane, 3rd edition, 1993, chapter 7.

The starting components (a) to (e) are for this purpose preferably mixed at a temperature of from 15 to 90° C., particularly preferably from 25 to 55° C., and the reaction mixture is introduced, optionally under superatmospheric pressure, into the mold. Mixing can be carried out mechanically by means of a stirrer or a stirring screw or under high pressure in countercurrent injection processes. The mold temperature is advantageously from 20 to 160° C., preferably from 30 to 120° C., particularly preferably from 30 to 60° C. For the purposes of the invention, the mixture of the components (a) to (e) at reaction conversions of less than 90%, based on the isocyanate groups, is referred to as reaction mixture.

The amount of reaction mixture introduced into the mold is calculated so that the moldings obtained, in particular integral foam, have a density of preferably from 150 g/l to 850 g/l, more preferably from 180 g/l to 600 g/l, particularly preferably from 200 g/l to 500 g/l and in particular from 220 to 400 g/l. The degrees of compaction for producing the polyurethane integral foams of the invention are in the range from 1.1 to 8.5, preferably from 1.6 to 7.0.

The polyurethane moldings of the invention are preferably used as shoe sole and particularly preferably as (through)sole, for example for street shoes, sports shoes, sandals and boots. In particular, the polyurethane integral foams of the invention are used as throughsole for sports shoes or as sole material of high-heeled ladies' shoes. Furthermore, polyurethane foams according to the invention can be used in interiors of vehicles, for example in cars as steering wheels, headrests or gearshift knobs or as seat armrests. Further possible uses are as armrests for chairs or as motorcycle saddles.

The invention is illustrated below with the aid of examples.

### EXAMPLES

The following compounds were used:
Iso1: isocyanate prepolymer based on 4,4′-MDI and about 10% by weight, based on the total weight of the isocyanates used for preparation of the prepolymer, of carbodiimide-modified and a mixture of polyesterols having an average functionality of 2.21 and an OHN of 38 mg KOH/g and based on adipic acid, monoethylene glycol, diethylene glycol and glycerol and diisotridecyl phthalate as additive and having an isocyanate content of 16.5% by weight
Iso2; isocyanate prepolymer having an isocyanate content of 18.9% by weight and based on 4,4′-MDI and about 10% by weight, based on the total weight of the isocyanates used for preparing the prepolymer, of carbodimide-modified MDI and polyesterol having a functionality of 2.0 and an OHN of 56 mg KOH/g and obtainable by polycondensation of adipic acid, MEG and butanediol.
Polyol1: polyesterol based on adipic acid, monoethylene glycol, diethylene glycol and glycerol and having an OH number of 56 mg KOH/g
Polyol2: polyethylene glycol having an OH number of 375 mg KOH/g
CE 1: monoethylene glycol
CE 2: 1,4-di(beta-hydroxypropyl)bisphenol A
CE3: 1-(beta-hydroxyethyl)-4-((2-hydroxyethoxy)ethyl)bisphenol A (Pluriol® BP 30 E)
Cat1: triethylenediamine in monoethylene glycol (33% by weight)
Additive 1: 10,10′-OXYBISPHENOXYARSINE
Additive 2: TRI-2-CHLOROISOPROPYL PHOSPHATE
Additive 3: quaternary ammonium ethosulfate (20% by weight) in monoethylene glycol
Additive 4: polysiloxane
Additive 5: ethoxylated glycerol, OH number 270 mg KOH/g

The starting materials were mixed as per table 1 and introduced into a closed mold having the dimensions 20 cm×20 cm×1 cm. All amounts of starting substances indicated in table 1 are parts by weight. The isocyanate index is 100 in all examples and comparative examples. The test plates obtained were conditioned under standard atmospheric conditions for 2 days before mechanical characterization was carried out. In the latter, the hardness, the rebound resilience in accordance with DIN 53512, the tear propagation resistance in accordance with DIN ISO 34-1, A, the tensile strength in accordance with DIN 53504 and the elongation at break in accordance with DIN 53543 were determined. To determine the hydrolysis properties, the test specimens were stored in accordance with DIN 53543 at 70° C. and 95% relative atmospheric humidity and the tensile strength and the elongation at break of the specimen were measured after 7, 14, 21 and/or 28 days of aging under hydrolysis conditions. The results of these measurements are likewise shown in table 1.

TABLE 1

| | Compar- | Exam- | Compar- | Exam- | Compar- |
|---|---|---|---|---|---|
| | ison 1 | ple 1 | ison 2 | ple 2 | ison 3 |
| Polyol 1 | 88.40 | 88.40 | 86.83 | 86.83 | 86.83 |
| Polyol 2 | 2.00 | 2.00 | 0.00 | 0.00 | 0.00 |
| CE 1 | 4.00 | 4.00 | 8.88 | 8.88 | 8.88 |
| CE 2 | 0.00 | 2.00 | 0.00 | 2.00 | 0.00 |
| CE3 | | | | | 2.00 |
| Cat 1 | 1.6 | 1.6 | 1.00 | 1.00 | 1.00 |
| Additive 1 | 0.93 | 0.93 | | | |
| Additive 2 | 4.42 | 4.42 | | | |
| Additive 3 | 1.04 | 1.04 | | | |
| Additive 4 | 0.75 | 0.75 | 0.40 | 0.40 | 0.40 |
| Additive 5 | 2 | 2 | 2.49 | 2.49 | 2.49 |
| Water | 0.45 | 0.45 | 0.4 | 0.4 | 0.4 |
| Iso | Iso 1 | Iso 1 | Iso 2 | Iso 2 | Iso 2 |
| Mass ratio | 100:81.7 | 100:83 | 100:96 | 100:96.5 | 100:96.3 |
| Properties: | | | | | |
| Density (g/l) | 500 | 500 | 500 | 500 | 500 |
| Hardness | 21 | 21 | 60 | 60 | 60 |
| (Shore A) | | | | | |
| Rebound | 43 | 41 | 46 | 42 | 40 |
| resilience (%) | | | | | |
| Tear | 3.6 | 2.9 | 11.9 | 12.3 | 12 |
| propagation | | | | | |
| resistance | | | | | |
| (N/mm) | | | | | |
| Tensile | 4.3 | 3.8 | 6.6 | 5.4 | 6.4 |
| strength | | | | | |
| (N/mm²) | | | | | |
| Elongation at | 471 | 445 | 370 | 372 | 423 |
| break (%) | | | | | |
| Tensile | | | 5.9 | 5.2 | 4.1 |
| strength 7 d | | | | | |
| Tensile | 2.6 | 3.5 | | | 1.2 |
| strength 14 d | | | | | |
| Tensile | | | 1.1 | 3.0 | 0.00 |
| strength 21 d | | | | | |
| Tensile | | | 0.6 | 1.4 | 0.00 |
| strength 28 d | | | | | |
| Elongation at | 486 | 496 | 432 | 413 | |
| break 7 d | | | | | |
| Elongation at | 527 | 505 | | | |
| break 14 d | | | | | |
| Elongation at | | | 84 | 345 | 414 |
| break 21 d | | | | | |
| Elongation at | | | 33 | 116 | 104 |
| break 28 d | | | | | |

The examples demonstrate that the addition of a bisphenol A-based polyol enables aging due to hydrolysis to be slowed while maintaining good mechanical properties.

1. A process for producing polyurethane moldings comprising:
combining organic polyisocyanates (a) with
compounds (b) having at least two hydrogen atoms that are reactive toward isocyanate, the compounds (b) including polyesterol (b1) and at least one compound (b2), which is obtained by alkoxylation of an aromatic starter molecule,
a blowing agent,
a catalyst, and
optionally other auxiliaries and/or additives to form a reaction mixture; and
introducing the reaction mixture into a mold and allowed to react to give a polyurethane molding having a density of from 150 to 850 g/l.

2. The process according to claim 1, wherein the aromatic starter molecule includes at least two benzene rings.

3. The process according to claim 1, wherein the aromatic starter molecule is a bisphenol or a derivative of a bisphenol.

4. The process according to claim 3, wherein the aromatic starter is bisphenol A or bisphenol S.

5. The process according to claim 1, wherein compound (b2) has a hydroxyl number of from 80 to 400 mg KOH/g.

6.-11. (canceled)

12. The process according to claim 3, wherein compound (b2) has a hydroxyl number of from 80 to 400 mg KOH/g.

13. The process according to claim 1, wherein the alkoxylation of compound (b2) is obtained with propylene oxide.

14. The process according to claim 1, wherein polyesterol (b1) is obtained by condensation of dicarboxylic acids having from 4 to 10 carbon atoms with a bifunctional and/or trifunctional, aliphatic alcohol.

15. The process according to claim 1, wherein compound (b) comprises, apart from components (b1) and (b2), less than 10% by weight of further polyols.

16. A polyurethane molding prepared by a process according to claim 1.

17. A shoe sole comprising a polyurethane molding according to claim 1.

18. A process for producing polyurethane foam moldings comprising:
combining organic polyisocyanates (a) with compounds (b) having at least two hydrogen atoms that are reactive toward isocyanate, wherein the compounds (b) include a polyesterol (b1) and at least one compound (b2), which is a bisphenol or a derivative of a bisphenol, a blowing agent, a catalyst, and optionally other auxiliaries and/or additives to form a reaction mixture; and
introducing the reaction mixture into a mold to form the polyurethane foam molding having a density of from 180 to 600 g/l, and a degree of compaction in the range from 1.6 to 7.0.

19. The process according to claim 18, wherein polyesterol (b1) is obtained by condensation of dicarboxylic acids having from 4 to 10 carbon atoms with a bifunctional and/or trifunctional, aliphatic alcohol.
